(19) United States
(12) Patent Application Publication
(10) Pub. No.: US 2026/0294081 A1
(43) Pub. Date: Oct. 1, 2026

(54) Wearable Instrument Tray

(71) Applicant: Innovative Dental Office Products LLC, Mapleton, UT (US)

(72) Inventors: Cory Michael Johnston, Mapleton, UT (US); John Caleb Lystrup, Provo, UT (US); Lincoln Philip Packer, Provo, UT (US); Brandon Thomas Wood, Sedro-Woolley, WA (US)

(21) Appl. No.: 19/631,750

(22) Filed: Mar. 27, 2026

Related U.S. Application Data
(60) Provisional application No. 63/780,145, filed on Mar. 28, 2025.

(51) Int. Cl. A45F 5/00; A61C 19/00

(52) U.S. Cl. CPC A45F 5/1575; A61C 19/00; A45F 2005/008

(57) ABSTRACT

A wearable instrument tray system includes a mount configured to be worn on a forearm of a user and a tray releasably attachable to the mount by magnetic force. The tray includes a working surface having a first raised area and a second raised area each configured to contact one or more instruments retained on the tray. A first magnet arrangement is associated with the first raised area and a second magnet arrangement is associated with the second raised area. The first and second magnet arrangements each serve a dual retention function of both releasably attaching the tray to the mount and magnetically retaining one or more instruments on the working surface of the tray, thereby maintaining essential instruments within convenient reach of the user during a procedure and reducing unnecessary bodily movement.

### CROSS-REFERENCE TO RELATED APPLICATION(S)

This application claims the benefit of U.S. Provisional Patent Application Ser. No. 63/780,145 filed Mar. 28, 2025, the entire disclosure of which is hereby incorporated by reference.

### TECHNICAL FIELD

This disclosure relates to instrument tray systems, and more particularly to wearable or body-mounted tray systems configured to retain instruments within convenient reach of a user during medical, dental, industrial, or other professional procedures.

### BACKGROUND

Professionals in medical, dental, industrial, and related fields frequently use multiple instruments or tools during the course of a procedure. Managing access to such instruments during a procedure can affect workflow efficiency, procedural outcomes, and the long-term physical well-being of the professional. There remains an ongoing need for improved instrument management solutions.

### SUMMARY

Disclosed herein are implementations of an instrument tray system (e.g., a wearable or body-mounted instrument tray system) configured for use in medical, dental, industrial, and related professional settings. The system may include a mount configured to be worn on a portion of a user's body, such as the forearm, and a tray releasably attachable to the mount and configured to retain one or more instruments within convenient reach of the user during a procedure. By maintaining instruments in an accessible and organized manner on or near the user's person, the system may reduce unnecessary bodily movement, improve workflow efficiency, and promote long-term ergonomic well-being.

The mount may comprise a sleeve, band, strap, wrap, or other wearable structure configured to be secured to the user's forearm or another portion of the user's body. The mount may be formed of an elastic or otherwise compliant material to comfortably accommodate a range of user anatomies, or may incorporate one or more adjustment mechanisms to allow the user to achieve a secure and comfortable fit. In certain implementations, the mount may be worn beneath an outer garment, such as a lab coat or surgical gown, with the tray attached to the exterior surface of the outer garment through magnetic coupling with the mount beneath. The mount may incorporate one or more magnets or ferromagnetic elements, which may be sewn, bonded, embedded, or otherwise affixed within or to the mount material, to provide a magnetic interface surface for attachment of the tray.

The tray may be a compact, lightweight platform configured to hold various instruments, tools, fasteners, and accessories. The tray may be fabricated from a polymeric material, such as an engineering thermoplastic, and may be formed by injection molding or another suitable molding process. The tray may be constructed from autoclave-safe or otherwise sterilizable materials, and may be interchangeable with other trays loaded with different instrument sets to facilitate rapid transitions between procedures.

The tray may include a first raised area and a second raised area on its working surface, which may serve as the primary contact regions between the tray and the instruments retained thereon. Each raised area may present an undulating outer surface defining a series of alternating ridges and valleys, wherein the ridges may space adjacent instruments from one another and the valleys may serve as seating locations that passively index each instrument into a defined resting position. The spacing between adjacent ridges may be selected to provide sufficient clearance for the user to individually grasp each instrument with their fingertips. In certain implementations, one or more valleys may be configured with a steeper, generally V-shaped profile to retain non-magnetic instruments through friction engagement, and may be formed from or coated with a resilient material such as an elastomer to enhance gripping force across a range of instrument geometries.

The tray may include one or more magnets or quantities of magnetic material housed within cavities (e.g., cavities formed on the lower surface of the tray beneath the raised areas). The magnets may be retained within the cavities by a friction or snap fit, facilitated by resilient flex of the tray material or by an elastomeric overmold on the cavity walls. The magnets may serve a dual retention function, simultaneously securing the tray to the mount and retaining ferromagnetic instruments on the working surface of the tray. In certain implementations, the tray may include a first row of magnets beneath the first raised area and a second row of magnets beneath the second raised area, wherein each row may engage a corresponding end of one or more instruments retained on the tray, maintaining the instruments in a desired alignment on the working surface.

The lower surface of the tray may be configured with a concave curvature to conform to the contours of the user's forearm, improving stability, comfort, and the distribution of instrument weight during extended use. The tray may further incorporate upwardly curling edges and rounded corners that may retain instruments on the working surface, shield instrument tips from inadvertent contact, and reduce the likelihood of snagging on clothing or other objects in the procedural environment. The tray may be asymmetric about its longitudinal axis to accommodate the differing medial and lateral contours of the forearm, and may include a label or other indicator identifying the interior-facing edge to facilitate correct orientation. The tray may be symmetric about its lateral axis, allowing a single tray configuration to be used interchangeably on either the left or right forearm of the user.

The tray may be attached to the mount magnetically, mechanically, or through a combination of both, and may be releasable from the mount with one hand during a procedure. In certain implementations, a quick-release mechanism may be provided to facilitate rapid tray removal and replacement. The tray may be configured for attachment not only to a body-worn mount but also to a nearby stationary surface, such as a medical cart, surgical table, dental unit, or workstation, providing flexibility across a variety of procedural environments and use cases.

### BRIEF DESCRIPTION OF THE DRAWINGS

The disclosure is best understood from the following detailed description when read in conjunction with the accompanying drawings. It is emphasized that, according to common practice, the various features of the drawings are not necessarily to-scale. The dimensions of the various features may be arbitrarily expanded or reduced for clarity.

FIG. 1 illustrates one implementation of a tray magnetically attached to mount configured as an arm sleeve worn by a user and with multiple dental instruments magnetically attached to the tray.

FIG. 2 illustrates a disassembled view of the tray and dental instruments of FIG. 1.

FIG. 3 is a top perspective view of the tray of FIG. 1.

FIG. 4 is a bottom perspective view of the tray of FIG. 1.

FIG. 5 is a cross-sectional view of the tray of FIG. 1.

FIG. 6 is another cross-sectional view of the tray of FIG. 1.

FIG. 7 is a top view of the tray of FIG. 1.

FIG. 8 is a bottom view of the tray of FIG. 1.

FIG. 9 is a first side view of the tray of FIG. 1.

FIG. 10 is a second side view of the tray of FIG. 1.

FIG. 11 is a first end view of the tray of FIG. 1.

FIG. 12 is a second end view of the tray of FIG. 1.

### DETAILED DESCRIPTION

The present disclosure relates to an ergonomic tray system configured for body-mounted or surface-mounted use in medical, dental, industrial, and related professional settings. The tray system is designed to maintain instruments, tools, fasteners, and other objects within convenient reach of a user, thereby reducing unnecessary bodily movement, improving workflow efficiency, and promoting long-term ergonomic well-being. The tray may utilize magnetic attachment, mechanical fastening, or a combination thereof to secure both the tray to a mounting surface or body-worn fixture and to retain instruments on the tray surface during use.

The tray may be a compact, lightweight platform configured to hold various tools and accessories. In certain implementations, the tray may be fabricated from stainless steel, aluminum, reinforced plastic, composite materials, or other suitable materials selected based on the intended application and applicable sterilization or cleaning requirements.

The working surface of the tray may be flat and smooth, curved, slightly textured, or may incorporate indentations, raised features, gripping elements, or other non-planar geometries configured to prevent instruments from slipping during use. The surface geometry may be adapted to particular applications or tool sets. In some implementations, the surface geometry may be shaped to conform to a portion of the user's anatomy, such as the forearm, to improve comfort during extended use. Padding may optionally be incorporated to further enhance user comfort.

The tray may include embedded or attached electronic components, including but not limited to sensors, gauges, displays, microchips, and printed circuit boards (PCBs). In certain implementations, the tray may be constructed from conductive materials configured to generate an electromagnetic field. Such a configuration may enhance instrument retention, provide an anti-static environment, or enable wireless charging for compatible electronic instruments.

The tray may additionally incorporate latches or other supplemental mechanical features to improve usability across a variety of work scenarios. A foldable or collapsible design may be employed in certain embodiments to facilitate storage and transport.

In certain implementations, the tray may include one or more magnets configured to provide secure attachment to ferromagnetic surfaces. The magnets may be embedded within the body of the tray or may comprise magnetic strips affixed to one or more surfaces of the tray. The magnets serve a dual function. For example, the magnets may secure the tray to a mounting fixture and retain ferromagnetic instruments on the tray surface during use.

In some embodiments, magnets or magnetic elements may be located on the instruments themselves, on the mounting fixture, or on both. Optional removable or adjustable magnets may be provided to allow the user to modify the holding strength of the tray as needed for a particular application or instrument set.

The tray may be configured for attachment to the user's body using a mount configured as an adjustable band, sleeve, or strap arrangement designed for comfort and stability during use. In various implementations, the mount may comprise hook-and-loop type fasteners, dual-lock materials, elastic bands, adhesives, slot-and-groove joints, mechanical clips, or other suitable fastening mechanisms.

Certain variations may include an adjustable mount configured to allow the user to position the tray at a desired angle relative to the mounting surface or the user's body. Additional configurations may incorporate a pivoting or rotating joint to further accommodate user preference and procedural requirements. Alternative mounts for connecting the tray to a fixture may include compliant or flexible surfaces configured to conform to the mounting location.

The tray may alternatively be configured for attachment to a nearby stationary surface, including but not limited to a medical cart, surgical table, dental unit, workstation, or sterilization cassette. Attachment to such surfaces may be achieved magnetically, mechanically, or through a combination of both. In certain implementations, a quick-release mechanism is provided to facilitate rapid removal and repositioning of the tray during a procedure.

In environments where magnetic attachment is not suitable, the tray may employ alternative attachment systems. Such alternatives may include suction cups, clamps, adhesive pads, or other non-magnetic fastening mechanisms configured to secure the tray to the desired mounting surface.

The tray may be constructed from autoclave-safe materials, allowing it to be removed and placed in an autoclave for sterilization between uses. Certain variations may support alternative cleaning methods depending on the materials used. In implementations utilizing interchangeable trays, a first tray loaded with a first instrument set may be readily replaced with a second tray loaded with a different instrument set, facilitating rapid transitions between procedures.

In certain implementations, the tray incorporates data collection functionality. Data may be collected relating to positional ergonomics, frequency of instrument placement and retrieval, instrument type, and other metrics. Such data may be used to enhance professional service quality, user productivity, product design, or the ergonomic experience of the user.

The tray system disclosed herein is applicable across a variety of professional fields. In medical and dental settings, surgeons, dentists, hygienists, and technicians may use the tray to keep essential instruments within convenient reach during procedures, reducing the need for repeated reaches to a separate instrument tray or cart. In industrial and assembly applications, technicians working with small components such as fasteners or electrical connectors may benefit from improved instrument accessibility and reduced repetitive motion. In emergency services contexts, paramedics and field personnel may utilize the tray for rapid access to critical instruments during time-sensitive procedures.

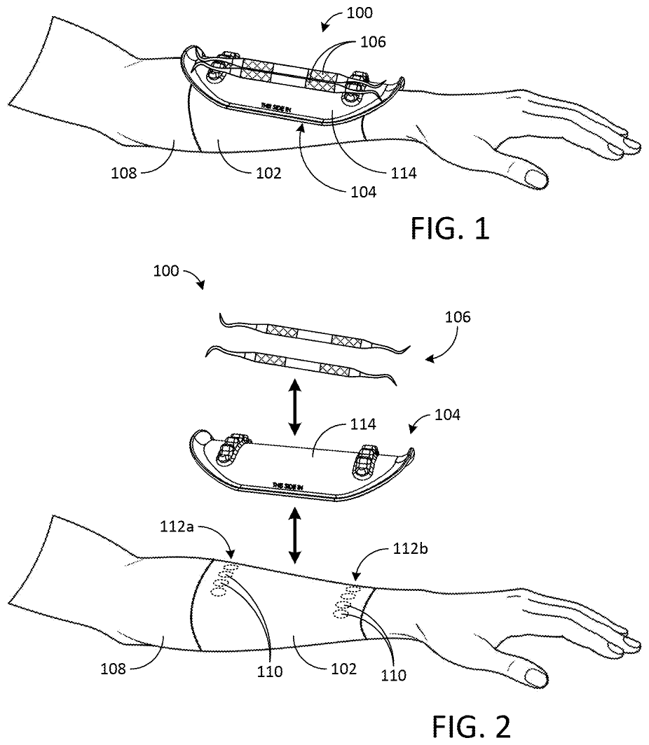

Referring to FIGS. 1 and 2, in selected implementations, a system 100 may include a mount 102, a tray 104, and one or more instruments 106 (e.g., one or more tools, accessories, fasteners, components, or the like). The mount 102 may be a structure (e.g., a wearable or body-mounted structure configured to be secured to a portion of a user's body) that provides a mounting interface for attachment (e.g., releasable attachment) of the tray 104. The mount 102 may position the tray 104 within convenient reach during a procedure or the like. In the illustrated implementation, the mount 102 is a sleeve configured to be worn on a portion of the forearm 108 of a user. The sleeve may be formed of an elastic or stretchable material, such as neoprene, spandex, or a similar compliant fabric, so as to comfortably accommodate a range of forearm sizes without requiring manual adjustment. In alternative implementations, the sleeve may incorporate one or more adjustment mechanisms, such as hook-and-loop fasteners, buckles, snap closures, sliding adjusters, or lacing systems, to allow the user to achieve a secure and comfortable fit across varying forearm dimensions. Accordingly, the sleeve may be formed of a material (e.g., fabric) that is substantially inextensible, and the one or more adjustment mechanisms may accommodate a range of forearm sizes.

The mount 102 is not limited to a sleeve configuration. In other implementations, the mount 102 may comprise a strap, band, wrap, glove, gauntlet, or other wearable structure configured to be secured to the forearm 108, wrist, upper arm, or another portion of the user's body. In still further implementations, the mount 102 may be integrated into an existing garment or personal protective equipment, such as a surgical gown, lab coat, or protective sleeve, allowing the tray 104 to be worn without requiring a separate accessory. The mount 102 may be disposable, reusable, or interchangeable, and may be constructed from washable materials.

The system 100 may be worn on either forearm 108 of the user. The choice of arm may be informed by the user's dominant hand, procedural requirements, or personal preference. For example, in a dental application, a dental hygienist who preferentially manipulates instruments 106 with their right hand may wear the system 100 on their left forearm 108. In this configuration, the tray 104 is positioned on the non-dominant arm, allowing the user to select instruments 106 with the dominant hand without redirecting attention away from the patient or the procedure. Conversely, a left-handed practitioner may wear the system 100 on their right forearm 108. In certain implementations, the system 100 may be configured to be worn simultaneously on both arms, for example, where a first tray holds a first instrument set and a second tray holds a second instrument set for sequential or concurrent use.

The tray 104 may be attached to the mount 102 magnetically, mechanically, or through a combination of both. In selected implementations, the mount 102 may incorporate a ferromagnetic or magnetic interface surface, and the tray 104 may include one or more magnets configured to releasably engage that surface, allowing the tray 104 to be quickly attached, repositioned, or removed with one hand during a procedure. In other implementations, the tray 104 may be connected to the mount 102 via a mechanical fastener, such as a clip, snap, slot-and-groove joint, hook-and-loop engagement, or pivoting mount, optionally allowing the tray 104 to be angled or rotated to a preferred orientation relative to the user's forearm 108. A quick-release mechanism may be incorporated to facilitate rapid detachment of the tray 104 from the mount 102, for example, to permit tray exchange between instrument sets or to allow for tray sterilization between procedures.

In certain implementations, the mount 102 may be worn beneath an outer garment, such as a lab coat, surgical gown, scrub top, or similar article of professional attire, while the tray 104 remains accessible on the exterior of the outer garment. For example, a dental hygienist or surgeon may don the mount 102, such as a forearm sleeve, prior to putting on a lab coat, such that the mount 102 is concealed beneath the outer garment during use. In such implementations, the tray 104 may be attached to or contact the outer surface of the outer garment, with a magnetic coupling force transmitted through the fabric of the outer garment to the mount 102 beneath. The fabric of the outer garment may thus be captured between the mount 102 and the tray 104, with the tray 104 held in position against the exterior surface of the outer garment by the attractive force between a magnetic element on the tray 104 and a corresponding ferromagnetic or magnetic interface on the mount 102. This configuration may be advantageous in environments where maintaining a clean or sterile outer garment surface is important, as the mount 102 is isolated from the procedural field, and the tray 104 may be removed and replaced without disturbing the outer garment. The thickness and material composition of the outer garment may be selected or accounted for to ensure that sufficient magnetic coupling force is maintained through the fabric to securely retain the tray 104 during normal procedural movements.

In certain implementations, magnets 110 or magnetic material may be incorporated directly into the mount 102 to facilitate secure attachment of the tray 104. For example, one or more magnets 110 or ferromagnetic elements may be sewn, bonded, embedded, overmolded, or otherwise affixed within or to the mount 102, such as within a dedicated pocket, channel, or layer of the material of a sleeve. The magnets 110 or magnetic material within the mount 102 may be distributed across one or more defined attachment zones to provide a broad and stable interface surface for engagement with the tray 104.

In certain implementations, the mount 102 may include a first mount row 112a of magnets 110 or magnetic material and a second mount row 112b of magnets 110 or magnetic material, each row configured to engage a corresponding magnetic or ferromagnetic region on the tray 104. The first mount row 112a and second mount row 112b may extend generally perpendicular to the longitudinal axis of the user's arm, such that the first mount row 112a is oriented transversely across the mount 102 proximate the elbow-facing end of the attachment zone and the second mount row 112b is oriented transversely across the mount 102 proximate the wrist-facing end of the attachment zone. This transverse arrangement may provide resistance to longitudinal displacement of the tray 104 along the length of the arm, for example due to the weight of instruments 106 retained on the tray 104 or forces encountered during normal procedural movements, while also distributing the attachment load across a greater surface area of the mount 102. Although not visible in the figures currently described, the tray 104 may include corresponding rows of magnets or magnetic material configured to engage the rows of the mount 102, as described in greater detail below.

In other implementations, the first mount row 112a and second mount row 112b of the mount 102 may instead extend parallel to the longitudinal axis of the arm, or at an oblique angle relative thereto, depending on the geometry of the tray 104 and the desired attachment characteristics. In still further implementations, the rows may be arranged in a converging or diverging pattern, or may follow a curved path conforming to the surface geometry of the mount 102 or the anatomy of the user's forearm 108. Additional rows of magnets or magnetic material may be incorporated into the mount 102, the tray 104, or both, to further enhance attachment strength or to accommodate trays 104 of varying sizes and geometries.

The first mount row 112a and the second mount row 112b of the mount 102 may further be arranged in a variety of configurations with respect to polarity. For example, the rows may be arranged such that like poles of adjacent magnets face one another, creating a flux concentration at the attachment interface that enhances holding strength. In other implementations, the poles may be alternated within and across rows to distribute the magnetic field more uniformly across the attachment surface. In certain implementations, the polarity arrangement may be selected to provide a degree of directional specificity to the attachment, such that the tray 104 engages the mount 102 securely only when oriented in a particular direction, thereby providing a consistent and repeatable positioning of the tray 104 on the user's arm.

The first mount row 112a and the second mount row 112b of the mount 102 may be spaced apart from one another, and the spacing between the rows, as well as the spacing between individual magnets 110 within each row, may be selected to optimize the balance between attachment strength, tray weight, and the ability to cleanly release the tray 104 from the mount 102 with one hand during a procedure. In certain implementations, removable or adjustable magnets 110 may be provided in the mount 102, the tray 104, or both, to allow the user to modify the holding strength as needed for a particular application or instrument set.

In certain implementations, one or more of the instruments 106 positioned on the tray 104 may be fabricated from or incorporate ferromagnetic material, or may include one or more magnets or magnetic elements, such that the instruments 106 are retained on an outer or working surface 114 of the tray 104 by magnetic force. In such implementations, the same magnets or rows of magnets incorporated into the tray 104 that serve to attach the tray 104 to the mount 102 may simultaneously function to retain the instruments 106 on the tray 104, such that the magnets or rows of magnets serve a dual retention purpose without requiring separate or dedicated magnetic elements for each function.

In certain implementations, the first row of magnets proximate the elbow-facing end of the tray 104 and the second row of magnets proximate the wrist-facing end of the tray 104 may each engage a corresponding end of one or more instruments 106 resting on the working surface 114 of the tray 104. In this arrangement, the first row of magnets may attract and retain a first end of an instrument 106, such as the handle or proximal end, while the second row of magnets simultaneously attracts and retains the opposite end of the instrument 106, such as the tip or distal end, thereby maintaining the instrument 106 in a desired orientation or alignment on the tray 104 (e.g., an arrangement where a length of the instrument 106 is aligned with and substantially parallel to the length of the forearm 108).

This dual-point retention may prevent the instruments 106 from rotating, shifting, or sliding on the tray surface during procedural movements, ensuring that each instrument 106 remains in a known and accessible position at all times. In certain implementations, the alignment provided by the dual-point retention may be particularly advantageous where instruments 106 of a similar appearance or form factor are stored on the tray 104 simultaneously, as consistent positioning may allow the user to rapidly identify and retrieve a desired instrument 106 by location alone without diverting visual attention from the procedure.

The spacing between the first mount row 112a and the second mount row 112b may accordingly be selected not only to optimize attachment of the tray 104 to the mount 102, but also to correspond to the length or geometry of one or more anticipated instruments 106, such that the rows engage the instruments 106 at or near their respective ends to maximize alignment stability. In implementations where instruments 106 of varying lengths are intended to be used with the tray 104, the spacing between rows, or the number and arrangement of rows, may be selected to accommodate the range of instrument lengths anticipated for a particular application or procedural context. For example, a tray 104 intended for use in a dental setting may be configured with row spacing corresponding to the typical length of common dental instruments, while a tray 104 intended for surgical or industrial use may be configured with different row spacing to accommodate the geometry of instruments 106 characteristic of those fields.

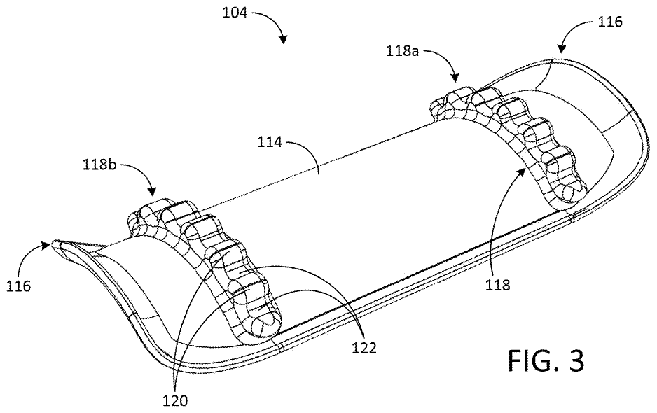

Referring to FIG. 3, in certain implementations, the tray 104 may be formed with a curvature configured to conform to the contours of the forearm 108 of the user or other body-mounted surface. Rather than being planar, the lower surface of the tray 104 may have a concave profile along its longitudinal axis, its transverse axis, or both, such that the tray 104 follows the natural curvature of the forearm 108 when attached to the mount 102. This conforming geometry may improve the stability of the tray 104 during use by increasing the contact area between the tray 104 and the mount 102, reducing the tendency of the tray 104 to rock or pivot relative to the forearm during procedural movements. The curvature may additionally improve user comfort during extended wear by distributing the weight of the tray 104 and any retained instruments 106 more evenly across the surface of the forearm 108 rather than concentrating load at discrete contact points.

The concave curvature of the lower surface of the tray 104 that allows the tray 104 to conform to the forearm 108 may also serve to improve both visual and manual access to the instruments 106 retained on the working surface 114. Because the working surface 114 of the tray 104 follows the curvature of the forearm 108 rather than lying flat, the working surface 114 presents a gently convex profile when viewed from above, such that instruments 106 retained toward the center of the tray 104 are elevated relative to those retained nearer the edges. This geometry may improve the user's sightline across the tray surface, allowing the user to more readily identify and distinguish between individual instruments 106 at a glance without repositioning the arm or diverting sustained attention from the procedure. The same convex presentation of the working surface 114 may similarly improve manual access, as the centrally positioned instruments 106 are lifted toward the user's approaching hand, reducing the reach and effort required to retrieve an individual instrument 106 cleanly during a procedure.

In certain implementations, the tray 104 may further incorporate rounded corners and edges 116 that curve upward and away from the forearm when the tray 104 is worn. The upwardly curling edges 116 may provide a raised peripheral boundary on at least opposite ends of the tray 104. The upwardly curling edges 116 may serve multiple purposes. First, the raised edges 116 may function as a retaining boundary that discourages instruments 106 from sliding off the working surface 114 of the tray 104 during use, particularly during arm movements or changes in orientation that might otherwise cause retained instruments 106 to shift toward the periphery of the tray 104. Second, the upwardly curved edges 116 may partially shield the ends or tips of instruments 106 retained on the tray 104, particularly those positioned near the periphery of the working surface 114, by presenting a raised boundary that reduces the likelihood of inadvertent contact between instrument tips and external objects, surfaces, clothing, or personnel in the procedural environment. This shielding function may be particularly advantageous in medical and dental settings where instrument tips may be sharp, delicate, or required to remain sterile, as the raised edges 116 may reduce the risk of tip damage, accidental injury, or contamination resulting from incidental contact. Third, the upwardly curved edges 116 and rounded corners may reduce the likelihood of the tray 104, or instruments 106 therein, snagging on clothing, gloves, tubing, or other objects in the procedural environment, thereby improving safety and ease of movement. Fourth, the absence of sharp edges or corners may facilitate cleaning and sterilization by eliminating geometric features that might otherwise trap contaminants or resist thorough cleaning.

The degree of curvature of the tray 104, both along its lower surface and at its edges 116, may be selected based on the intended application and the anatomy of the intended user population. In certain implementations, the tray 104 may be offered in a range of curvature profiles to accommodate users with different forearm geometries, or the tray 104 may be fabricated from a material having sufficient compliance to conform passively to the forearm of a particular user upon attachment to the mount 102. The transition between the working surface 114 and the upwardly curling edges 116 may be gradual and smooth, presenting a continuous and uninterrupted surface that is comfortable against incidental contact with the user's opposite hand or the hands of an assistant during a procedure.

In certain implementations, the tray 104 may be orientation specific with respect to its lateral axis, such that a designated edge of the tray 104 is intended to face the interior of the user's body, toward the user's core, when the tray 104 is properly attached to the mount 102. To facilitate correct orientation, the tray 104 may include a label, marking, indicia, tactile feature, or other indicator identifying which edge is the interior-facing or medial edge. Such orientation specificity may arise, for example, from a curvature profile or edge geometry that is optimized for the medial and lateral aspects of the forearm 108, respectively, which present different anatomical contours. Accordingly, the tray 104 may be asymmetric about its longitudinal axis, such that the interior-facing edge and the exterior-facing edge have different profiles, curvatures, or geometries tailored to the corresponding aspect of the forearm 18. At the same time, the tray 104 may be symmetric about its transverse axis, such that the elbow-facing end and the wrist-facing end of the tray 104 are mirror images of one another. This end-to-end symmetry may allow a single tray 104 to be used interchangeably on either the left forearm or the right forearm of the user without requiring a separate tray configuration for each arm, as the user need only ensure that the labeled interior-facing edge is oriented toward the core regardless of which arm the system 100 is worn on.

In certain implementations, the working surface 114 of the tray 104 may include one or more raised areas 118 (e.g., a first raised area 118a and a second raised area 118b) that together define the primary contact regions between the tray 104 and the instruments 106 retained thereon. For example, rather than supporting instruments 106 across the entirety of the working surface 114, the tray 104 may be configured such that a first raised area 118a and a second raised area 118b are the only portions of the working surface 114 specifically intended to contact the instruments 106, with the remainder of the working surface 114 recessed relative to the raised areas.

This configuration may reduce the overall contact area between the instruments 106 and the tray 104, which may also reduce the force required to retrieve an individual instrument 106 from the tray 104 by limiting the area of magnetic engagement between the instrument 106 and the tray surface. Additionally, because the instruments 106 are supported on raised areas 118 rather than lying flush against a planar working surface 114, a user may more readily access and grip individual instruments 106 with their fingertips, as the elevation of the instruments 106 above the surrounding recessed surface provides clearance for the user's fingers to engage the underside or sides of an instrument 106 and lift it cleanly away from the tray 104 without interference from the surrounding surface.

In certain implementations, the first raised area 118a and the second raised area 118b may correspond in position to the first and second rows of magnets or magnetic material within the tray 104, such that the raised areas 118 bring the instruments 106 into closer proximity with the underlying magnets, thereby enhancing the magnetic retention force acting on each instrument 106. The raised areas 118 may thus serve a dual purpose, functioning both as the primary mechanical support surfaces for the instruments 106 and as the regions of greatest magnetic engagement between the instruments 106 and the tray 104.

The outer surface of a raised area 118 may be undulating rather than planar, defining a series of alternating ridges 120 and valleys 122 extending across the width of the raised area 118. The ridges 120 may serve to laterally space one instrument 106 from another, preventing adjacent instruments 106 from contacting one another while retained on the tray 104, which may be particularly important in settings where instrument tips must remain sterile or undamaged. The valleys 122 defined between adjacent ridges 120 may serve as seating locations where individual instruments 106 naturally come to rest when placed on the tray 104, with the flanking ridges 120 encouraging each instrument 106 to settle into and remain within a corresponding valley 122. This geometry may provide a degree of passive indexing, guiding each instrument 106 toward a defined resting position on the tray 104 and maintaining consistent instrument spacing and alignment during use.

The spacing between adjacent ridges 120, and accordingly the width of each valley 122, may be selected to provide sufficient clearance for the user's fingers to individually access and grasp each instrument 106 without inadvertently contacting or displacing an adjacent instrument 106, which may be particularly advantageous where instruments 106 of similar appearance are stored in close proximity on the tray 104. The width and depth of the valleys 122 may further be selected to correspond to the diameter or cross-sectional geometry of the instruments 106 anticipated for a particular application, such that each instrument 106 is comfortably seated within a valley 122 without excessive play or unintended lateral displacement during procedural movements.

In certain implementations, one or more of the instruments 106 intended for use with the tray 104 may not be fabricated from ferromagnetic material and may not incorporate magnets or magnetic elements, such that magnetic retention alone may be insufficient to reliably secure such instruments 106 to the working surface 114 of the tray 104. To accommodate such instruments 106, the tray 104 may include one or more dedicated locators configured to retain non-magnetic instruments 106 on the tray 104 through means other than magnetic force. In certain implementations, such locators may be positioned in the recessed regions of the working surface 114 between or alongside the raised areas 118, or may be incorporated into the raised areas 118 themselves, depending on the geometry and intended instrument set of a particular tray 104 configuration.

In certain implementations, a locator may comprise a valley 122 having a relatively steep profile, such as a generally V-shaped cross-section, configured to receive and wedge an instrument 106 therein through friction engagement. As an instrument 106 is pressed into the V-shaped valley, the converging walls of the valley 122 bear against the outer surface of the instrument 106, generating a frictional gripping force that resists removal of the instrument 106 during normal procedural movements while still permitting deliberate retrieval by the user with reasonable effort. The steepness of the V-shaped profile may be selected based on the diameter or cross-sectional geometry of the intended instrument 106 and the desired retention force, with a narrower included angle generally producing a greater wedging and frictional engagement. In certain implementations, the walls of the V-shaped valley, or the entirety of the locator, may be formed from or coated with a resilient material, such as an elastomer overmolded onto the tray body, to enhance the frictional gripping force and accommodate instruments 106 of varying diameters within a single locator. The compliance of the resilient material may allow the valley walls to deform slightly upon insertion of an instrument 106, conforming to the outer surface of the instrument 106 and increasing the contact area between the locator and the instrument 106, thereby improving retention reliability across a range of instrument geometries and surface finishes.

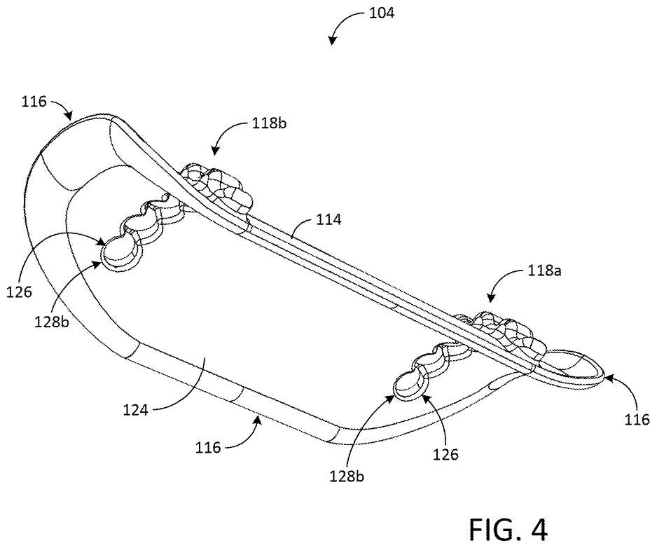

Referring to FIG. 4, in certain implementations, the raised areas 118 (e.g., the first raised area 118a and the second raised area 118b) of the working surface 114 of the tray 104 may also serve a structural purpose on the lower surface 124 of the tray 104 by defining or creating space for one or more cavities 126 formed in the underside of the tray body beneath each raised area 118. Because the raised areas 118 project upward from the general plane of the working surface 114, the corresponding regions on the lower surface 124 of the tray 104 may present space for a void or cavity 126 of sufficient depth to house one or more magnets or magnetic elements without increasing the overall profile of the tray 104 or encroaching on the working surface 114 above.

In this manner, the geometry of the raised areas 118 may serve a dual purpose, providing the instrument contact and indexing features described above on the working surface 114 of the tray 104 while simultaneously creating the spatial envelope necessary to accommodate the magnetic retention components on the lower surface 124. One or more magnets or magnetic elements may be associated with each raised area 118, such that the first raised area 118a is associated with a first tray row 128a of magnets or magnetic material and the second raised area 118b is associated with a second tray row 128b of magnets or magnetic material.

In certain implementations, one or more magnets or quantities of magnetic material may be housed within the cavities 126 formed beneath the raised areas 118. The magnets or magnetic material may be arranged within the cavities 126 in a variety of configurations depending on the desired magnetic field distribution, attachment strength, and manufacturing considerations. In certain implementations, a friction fit between the magnet and the walls of the cavity 126 may be sufficient to retain the magnet securely within the cavity without requiring adhesive, fasteners, or any other supplemental retention mechanism, such that the magnet may be effectively snapped into place during assembly and held therein by the interference or frictional engagement between the magnet geometry and the walls of the cavity 126.

To facilitate this snap-fit engagement and reliable retention, the bulk material of the tray 104 may be selected to exhibit a certain degree of resilient flex, allowing the cavity walls to deflect slightly upon insertion of a magnet and return elastically to their original geometry once the magnet is fully seated, thereby generating the desired engagement or fit. In alternative implementations, rather than relying on the bulk material properties of the tray 104, the region of the tray 104 defining the cavity walls, or some portion thereof, may be overmolded with an elastomeric material configured to provide the desired degree of deflection upon magnet insertion, resilient return upon seating, and sustained gripping force during use. The elastomeric overmold may also serve to dampen vibration transmitted to the magnets during procedural movements and may provide a degree of environmental sealing around the seated magnets, reducing the ingress of contaminants into the cavities 126 during use.

The snap-fit arrangement, whether achieved through bulk material flex, elastomeric overmolding, or some other mechanism, may also facilitate removal and replacement of individual magnets, for example, to allow the user to adjust the holding strength of the tray 104 by substituting magnets of different strengths. In certain implementations, the cavities 126 may be sized to accept a range of magnet thicknesses or grades, providing the user (or an assembler or manufacturer) with flexibility to tune the magnetic retention characteristics of the tray 104 for a particular application or instrument set without requiring a different tray 104 configuration.

In certain implementations, the cavities 126 formed beneath a raised area 118 may comprise a series of discrete or overlapping recesses arranged in a row along the length of the raised area 118, each recess configured to receive an individual magnet of a corresponding geometry. The rows of magnets or magnetic material housed within the cavities 126 of the tray 104 may comprise a first tray row 128a and a second tray row 128b, each corresponding to a respective raised area 118a, 118b. The first tray row 128a and the second tray row 128b may be sized and shaped such that, when the system 100 is assembled for use (e.g., when the tray 104 is applied or secured to the mount 102), the first tray row 128a overlays the first mount row 112a and the second tray row 128b overlays the second mount row 112b, facilitating aligned magnetic engagement between the tray 104 and the mount 102.

In one such implementation, each recess may be generally circular in plan view and sized to receive a disc-shaped magnet, such that a row of circular recesses extending along the base of a raised area 118 may be populated with a corresponding row of circular disc magnets. In this arrangement, the first tray row 128a and the second tray row 128b of disc magnets may collectively span substantially the full length of their respective raised areas 118, such that the base of each raised area 118 is effectively filled with magnetic material along its length, providing a substantially continuous magnetic engagement zone along each raised area 118.

The diameter and thickness of the disc magnets, as well as the spacing between adjacent recesses within each row, may be selected to achieve a desired balance between magnetic field strength, coverage, tray weight, and cost. In certain implementations, the recesses of a given row may be sized to accept a standard off-the-shelf disc magnet geometry, reducing manufacturing complexity and facilitating field replacement of individual magnets as needed.

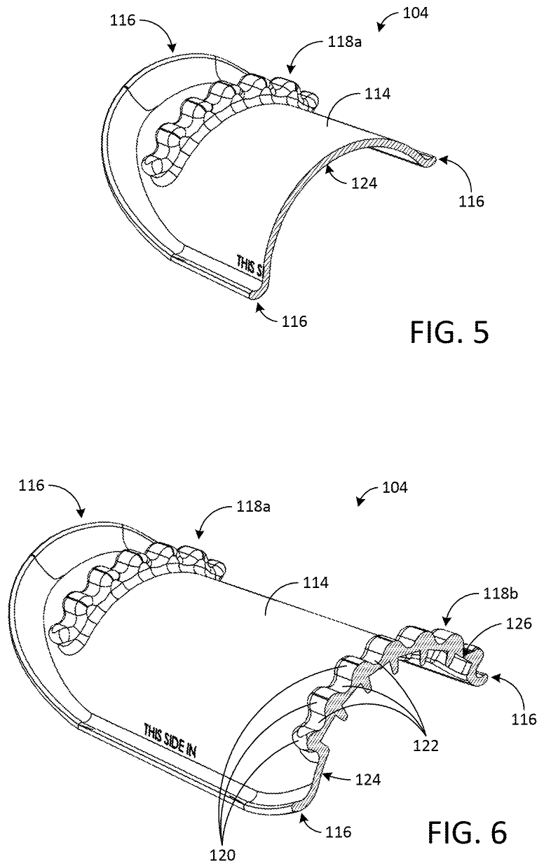

Referring to FIG. 5, a cross-sectional view of the tray 104 taken at a location between the first raised area 118a and the second raised area 118b illustrates a general thickness profile and curvature of the tray body. As shown, the tray 104 may present a gently concave lower surface 124 and a correspondingly convex working surface 114 in this region, reflecting the anatomical curvature described above that allows the tray 104 to conform to the contours of the user's forearm when attached to the mount 102. The cross-section in this region illustrates the upwardly curled edges 116 that may extend along the lateral extremes of the tray 104. The cross-section in this region also illustrates that the tray body may maintain a relatively uniform wall thickness between the working surface 114 and the lower surface 124, which may be selected to provide an appropriate balance between structural rigidity, overall tray weight, and the resilient flex characteristics relied upon for magnet retention as described above.

Referring to FIG. 6, a cross-sectional view taken through the second raised area 118b more clearly illustrates the undulating geometry of the working surface 114 in the instrument contact region. As shown, the raised area 118b may project upward from the general plane of the working surface 114 and may present an outer surface defined by a series of alternating ridges 120 and valleys 122 extending transversely across the width of the tray 104. The ridges 120 may project upward from the raised area 118b to define the lateral spacing boundaries between adjacent instruments 106, while the valleys 122 defined between adjacent ridges 120 may provide the seating locations within which individual instruments 106 come to rest when placed on the tray 104, as described above. The cross-sectional profile of the valleys 122 may vary depending on the intended application, ranging from a relatively broad and shallow U-shaped profile suited to magnetically retained instruments 106 to a narrower and steeper V-shaped profile configured to wedge and frictionally retain non-magnetic instruments 106, as also described above.

As further shown in FIG. 6, one or more cavities 126 may be defined on the lower surface 124 of the tray 104 beneath the raised area 118b. The cavities 126 may be positioned directly below the raised area 118b such that the spatial envelope created by the upward projection of the raised area 118b on the working surface 114 may be utilized on the underside of the tray 104 to house the magnets or magnetic material that provide instrument retention and tray attachment functionality. The cross-sectional view illustrates one possible relationship between the undulating upper geometry of the raised area 118b and the cavity or cavities 126 below, and shows how the wall thickness of the tray body in this region may be maintained at a level sufficient to provide structural integrity between the working surface features and the magnet-receiving cavities 126 beneath.

In certain implementations, the tray 104, given the complexity of its geometry, including the concave lower surface 124, the raised areas 118, the undulating ridge and valley profile of the working surface 114, the upwardly curling edges 116, and the magnet-receiving cavities 126 on the lower surface, may be suited to manufacture by injection molding or another molding process using a polymeric material. Injection molding may allow the full three-dimensional geometry of the tray 104 to be formed in a single operation with a high degree of dimensional repeatability, which may ensure consistent magnet fit within the cavities 126 and consistent instrument seating within the valleys 122 across production units. Suitable polymeric materials may include engineering thermoplastics such as acrylonitrile butadiene styrene (ABS), polycarbonate, nylon, polypropylene, or glass-filled variants thereof, selected based on the mechanical properties, chemical resistance, sterilization compatibility, and food or medical grade certification requirements of the intended application. In implementations incorporating an elastomeric overmold on the cavity walls, the valley surfaces, or both, a two-shot or insert molding process may be employed to deposit the elastomeric material onto the formed tray body in a subsequent molding operation, producing a unitary component with regions of differing material properties in a single finished part.

In certain implementations, the tray 104 may alternatively be formed by other manufacturing processes, such as thermoforming, compression molding, or additive manufacturing, depending on production volume, material requirements, and design iteration needs. For example, additive manufacturing may be particularly suitable for producing custom tray configurations, or for producing trays 104 tailored to the specific anatomical geometry of an individual user's forearm. Regardless of the manufacturing process employed, the material and wall thickness of the tray 104 may be selected in conjunction with the geometry of the cavities 126 to enable the cavity walls to exhibit the degree of resilient flex for snap-fit magnet retention as described above, while maintaining sufficient structural rigidity to support the instruments 106 and withstand the mechanical demands of repeated use, cleaning, and sterilization cycles.

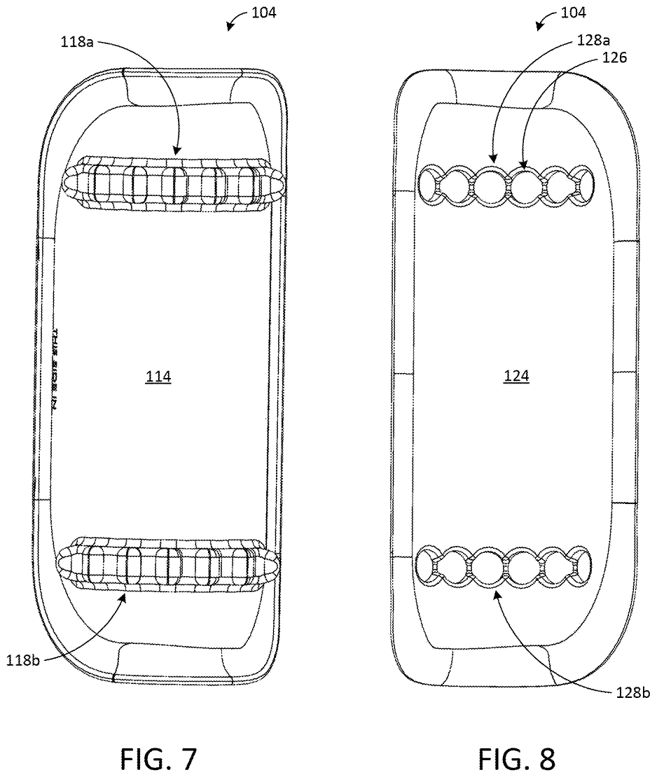

Referring to FIG. 7, a top view of the tray 104 illustrates one implementation of the overall plan geometry of the working surface, which may include the first raised area 118a and the second raised area 118b extending transversely across the tray 104, the undulating ridge and valley profile of each raised area, and generally recessed working surface regions between and surrounding the raised areas. In the illustrated implementation, the tray 104 may be symmetric about its lateral axis, such that the elbow-facing end and the wrist-facing end of the tray 104 may present substantially mirror-image geometries, which may allow the tray 104 to be used interchangeably on either the left or right forearm of the user as described above. The top view may further illustrate one implementation of the asymmetry of the tray 104 about its longitudinal axis, which may reflect the orientation-specific geometry of the interior-facing and exterior-facing edges described above, though other implementations may exhibit different degrees or forms of lateral asymmetry depending on the intended application.

Referring to FIG. 8, a bottom view of the tray 104 illustrates one implementation of the concave lower surface profile of the tray body, and may show one possible arrangement of the magnet-receiving cavities 126 beneath the first raised area 118a and the second raised area 118b. The bottom view may further illustrate the lateral symmetry (i.e., symmetry across a lateral or transverse axis) and longitudinal asymmetry (i.e., asymmetry across a longitudinal or lengthwise axis) of the tray 104 as described above, and may show one implementation of the upwardly curling edges as they may appear when the tray 104 is viewed from below. Other implementations may employ different lower surface geometries, arrangements of cavities 126, or edge profiles as appropriate for the intended application.

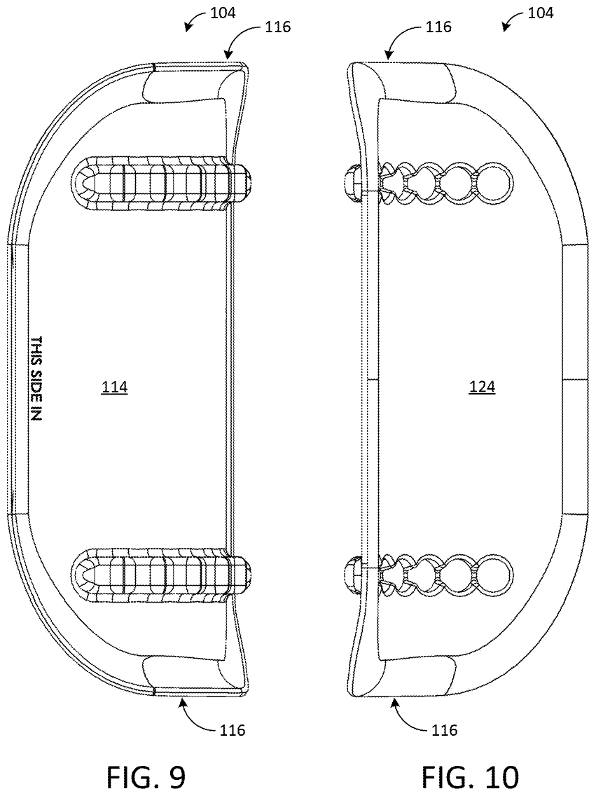

Referring to FIG. 9 and FIG. 10, first and second side views of the tray 104 may illustrate one implementation of the longitudinal profile of the tray 104 as seen from the interior-facing edge and the exterior-facing edge, respectively. In the illustrated implementation, the two side profiles may differ from one another, reflecting one possible expression of the asymmetry of the tray 104 about its longitudinal axis, such that the interior-facing edge and the exterior-facing edge may present different curvatures, heights, or geometric features when viewed from the side. Each side view may illustrate one implementation of the upward curvature of the tray 104 at its ends, the general concave curvature of the lower surface 124 configured in this implementation to conform to the contours of the forearm 108, and the projection of the raised areas 118a and 118b above the working surface 114 as seen in profile. The relative heights of the raised areas 118a and 118b, the degree of end curvature, and the overall silhouette of the tray 104 as seen from each side may vary across implementations depending on the intended application, the anatomy of the intended user population, and the instrument set for which the tray 104 is configured. Other implementations may exhibit different side profiles, edge curvatures, or degrees of longitudinal asymmetry than those illustrated.

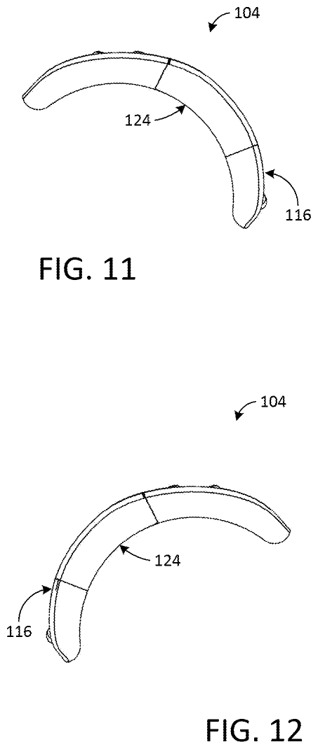

Referring to FIG. 11 and FIG. 12, first and second end views of the tray 104 may illustrate one implementation of the transverse profile of the tray 104 as seen from the elbow-facing end and the wrist-facing end, respectively. In the illustrated implementation, the two end profiles may be substantially mirror images of one another, consistent with one possible expression of the end-to-end symmetry of the tray 104 about its lateral axis described above. The end views may further illustrate one implementation of the concave curvature of the lower surface 124, the upwardly curling lateral edges 116, and the overall cross-sectional geometry of the tray body as seen from each end. Other implementations may employ different end geometries, curvature profiles, or degrees of end-to-end symmetry depending on the intended use and manufacturing considerations.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A wearable instrument tray system comprising:
a mount configured to be worn on a body of a user; and
a tray releasably attachable to the mount, the tray comprising one or more magnets configured to both releasably attach the tray to the mount and magnetically retain one or more instruments on a working surface of the tray.

2. The wearable instrument tray system of claim 1, wherein the mount is a sleeve sized to be worn on a forearm of the user.

3. The wearable instrument tray system of claim 1, wherein the mount comprises one or more magnets or ferromagnetic elements configured to magnetically engage the one or more magnets of the tray to releasably attach the tray to the mount.

4. The wearable instrument tray system of claim 1, wherein the one or more magnets of the tray comprise a first tray row of magnets and a second tray row of magnets spaced apart from one another.

5. The wearable instrument tray system of claim 4, wherein:
the mount comprises a first mount row of magnets or magnetic material and a second mount row of magnets or magnetic material spaced apart from one another; and
when the tray is applied to the mount, the first tray row is positioned to overlay and magnetically engage the first mount row and the second tray row is positioned to overlay and magnetically engage the second mount row.

6. The wearable instrument tray system of claim 1, wherein:
the working surface comprises a first raised area and a second raised area; and
the one or more magnets are positioned beneath the first raised area and the second raised area, respectively.

7. The wearable instrument tray system of claim 6, wherein the first raised area and the second raised area each present an undulating surface profile defining a plurality of ridges and a plurality of valleys.

8. The wearable instrument tray system of claim 1, wherein the tray has a lower surface with a concave curvature configured to conform to a contour of a forearm of the user.

9. The wearable instrument tray system of claim 1, wherein the mount is configured to be worn beneath an outer garment and the tray is configured to attach to an exterior surface of the outer garment through magnetic coupling with the mount beneath the outer garment.

10. The wearable instrument tray system of claim 1, wherein the one or more magnets are housed within one or more cavities formed on a lower surface of the tray and are retained within the one or more cavities by a friction fit.

11. A wearable instrument tray system comprising:
a mount configured to be worn on a forearm of a user; and
a tray releasably attachable to the mount by magnetic force, the tray comprising:
a working surface comprising a first raised area and a second raised area, each configured to contact one or more instruments retained on the tray; and
a first magnet arrangement associated with the first raised area and a second magnet arrangement associated with the second raised area, wherein the first magnet arrangement and the second magnet arrangement are each configured to serve a dual retention function of both releasably attaching the tray to the mount and magnetically retaining one or more instruments on the working surface of the tray.

12. The wearable instrument tray system of claim 11, wherein the tray has a lower surface with a concave curvature configured to conform to a contour of the forearm of the user when the tray is attached to the mount.

13. The wearable instrument tray system of claim 12, wherein the concave curvature of the lower surface extends along a longitudinal axis of the tray.

14. The wearable instrument tray system of claim 12, wherein the concave curvature of the lower surface causes the working surface to present a generally convex profile when viewed from above.

15. The wearable instrument tray system of claim 11, wherein the tray comprises upwardly curling edges configured to curve away from the mount.

16. The wearable instrument tray system of claim 15, wherein the upwardly curling edges provide a raised peripheral boundary on at least opposite ends of the tray.

17. The wearable instrument tray system of claim 16, wherein the tray is symmetric about a lateral axis of the tray, such that the tray is configured to be worn interchangeably on either a left forearm or a right forearm of the user.

18. The wearable instrument tray system of claim 17, wherein the tray further comprises an indicator identifying an interior-facing edge of the tray to facilitate correct orientation of the tray on a forearm of the user.

19. The wearable instrument tray system of claim 11, wherein the first magnet arrangement is housed within one or more cavities formed on a lower surface of the tray beneath the first raised area and the second magnet arrangement is housed within one or more cavities formed on the lower surface of the tray beneath the second raised area.

20. A wearable instrument tray system comprising:
a mount configured to be worn on a forearm of a user, the mount comprising a first mount magnet arrangement and a second mount magnet arrangement each incorporated into the mount and spaced apart from one another along a longitudinal axis of the mount; and
a tray releasably attachable to the mount, the tray comprising:
a lower surface having a concave curvature configured to conform to a contour of the forearm of the user;
a working surface opposite the lower surface, the working surface comprising a first raised area and a second raised area each extending transversely with respect to the longitudinal axis, the first raised area and the second raised area each presenting an undulating surface profile defining a plurality of ridges and a plurality of valleys, wherein the plurality of valleys are configured to receive and seat one or more instruments retained on the working surface; and
a first magnet arrangement positioned beneath the first raised area and a second magnet arrangement positioned beneath the second raised area, wherein the first magnet arrangement is configured to magnetically engage the first mount magnet arrangement and the second magnet arrangement is configured to magnetically engage the second mount magnet arrangement to releasably attach the tray to the mount, and wherein the first magnet arrangement and the second magnet arrangement are further configured to magnetically retain one or more ferromagnetic instruments on the working surface of the tray.
